(19) United States
(12) Patent Application Publication
(10) Pub. No.: US 2014/0238299 A1
(43) Pub. Date: Aug. 28, 2014

(54) ELECTRODE FABRICATING APPARATUS FOR RECHARGEABLE BATTERY

(71) Applicant: Samsung SDl Co., Ltd., Yongin-si (KR)

(72) Inventor: Ja-Hoon Cho, Yongin-si (KR)

(73) Assignee: Samsung SDl Co., Ltd., Yongin-si (KR)

(21) Appl. No.: 14/147,273

(22) Filed: Jan. 3, 2014

(30) Foreign Application Priority Data
Feb. 28, 2013 (KR) 10-2013-0022378

(51) Int. Cl. H01M 4/04; H01M 4/139

(52) U.S. Cl. CPC H01M 4/0421; H01M 4/139
USPC 118/712; 118/722; 118/726

(57) ABSTRACT

An electrode fabricating apparatus for a rechargeable battery according to the present invention includes: a vacuum chamber having an inner space; and a lithium depositor receiving a lithium source and having an evaporation unit heating and evaporating the lithium source, and a nozzle unit positioned on the evaporation unit and controlling an aperture ratio to control a deposition amount of lithium.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

This application claims priority to and the benefit of Korean Patent Application No. 10-2013-0022378 filed in the Korean Intellectual Property Office on Feb. 28, 2013, the entire contents of which are incorporated herein by reference.

### BACKGROUND

1. Field

The described technology relates generally to an electrode fabricating apparatus for a rechargeable battery. More particularly, the described technology relates generally to an electrode fabricating apparatus for a rechargeable battery for depositing lithium.

2. Description of the Related Technology

Unlike a primary battery that cannot be recharged, a rechargeable battery (i.e., secondary battery or a secondary cell) can be repeatedly charged and discharged. A low capacity rechargeable battery is used for small electronic devices such as mobile phones, notebook computers, camcorders, and the like, and a large-capacity rechargeable battery is commonly used as a power source for driving a motor of a hybrid electric vehicle and the like.

The rechargeable battery includes an electrode assembly including a negative electrode, a positive electrode, and a separator. The electrode assembly is wound with the separator interposed between the positive electrode and the negative electrode, or the positive electrode and the negative electrode are alternately laminated with the separator interposed therebetween.

Lithium ions existing at the positive electrode before charging are moved to the negative electrode after the charge. Also, after discharge, the lithium ions that were in the negative active material must be moved to the positive electrode active material, however, some lithium ions remain in the negative active material such that capacity of the rechargeable battery is decreased.

The above information disclosed in this Background section is only for enhancement of understanding of the background of the invention, and therefore it may contain information that does not form prior art that is already known in this country to a person of ordinary skill in the art.

### SUMMARY OF CERTAIN INVENTIVE ASPECTS

The present invention provides an electrode fabricating apparatus in which a deposition amount of lithium is easily controlled.

An electrode fabricating apparatus of a rechargeable battery according to the present invention includes: a vacuum chamber having an inner space; and a lithium depositor receiving a lithium source and having an evaporation unit heating and evaporating the lithium source, and a nozzle unit having an aperture positioned on the evaporation unit wherein the aperture is controlled by controlling an aperture ratio to control a deposition amount of lithium.

The nozzle unit may include a first open/close plate installed to be rotated, and the nozzle unit may include a second open/close plate disposed to face the first open/close plate and installed to be rotated.

The first open/close plate may include a motor rotating the first open/close plate, and a rotation axis point of the first open/close plate may be connected to and installed with a first gear, and a rotation axis point of the second open/close plate may be connected to and installed with a second gear coupled to the first gear.

The first open/close plate and the second open/close plate may include a heating line, and the nozzle unit may have a side wall and the heating line is installed at the side wall.

The nozzle unit may include side walls; the side walls facing each other may include a sensing hole, and the electrode fabricating apparatus may further include a sensor detecting a deposition amount of the lithium through the sensing hole.

A plurality of holes may be formed at the first open/close plate and the second open/close plate, and the evaporation unit may have a side wall and the side wall is installed with the heating line for heating.

A lithium supply pipe to supply the lithium in the evaporation unit may be connected and installed at one side wall of the evaporation unit, and a bottom of the evaporation unit may include a drain hole to exhaust an impurity.

A winding roller wounded with an electrode, a spiral-wound roller wound with the electrode on which the lithium is deposited, and a moving drum positioned on the lithium depositor and supporting the electrode may be installed in the vacuum chamber.

The electrode fabricating apparatus may include two lithium depositors, and one lithium depositor of the lithium depositors may deposit the lithium on a first surface of the electrode and the other lithium depositor may deposit the lithium on a second surface of the electrode.

According to an exemplary embodiment of the present invention, the deposition amount of the lithium may be easily controlled by providing the nozzle unit. Also, the aperture ratio of the nozzle unit may be easily and quickly controlled by providing the open/close plates.

### BRIEF DESCRIPTION OF THE DRAWINGS

FIG. 1 is a schematic diagram of an electrode fabricating apparatus according to the first exemplary embodiment of the present invention.

FIG. 2 is a perspective view of a lithium depositor according to the first exemplary embodiment of the present invention.

FIG. 3 is a cut perspective view of a lithium depositor according to the first exemplary embodiment of the present invention.

FIG. 4 is a perspective view of an open/close plate according to the first exemplary embodiment of the present invention.

FIG. 5 is a cross-sectional view to explain control of an aperture ratio of a nozzle unit according to rotation of the open/close plate according to the first exemplary embodiment of the present invention.

FIG. 6 is a cross-sectional view showing a state that a nozzle unit is closed according to rotation of the open/close plate according to the first exemplary embodiment of the present invention.

FIG. 7 is a schematic diagram of an electrode fabricating apparatus according to the second exemplary embodiment of the present invention.

### DETAILED DESCRIPTION OF CERTAIN INVENTIVE EMBODIMENTS

The present invention will be described more fully hereinafter with reference to the accompanying drawings, in which exemplary embodiments of the invention are shown. As those skilled in the art would realize, the described embodiments may be modified in various different ways, all without departing from the spirit or scope of the present invention. Like numbers refer to like elements throughout the specification and drawings.

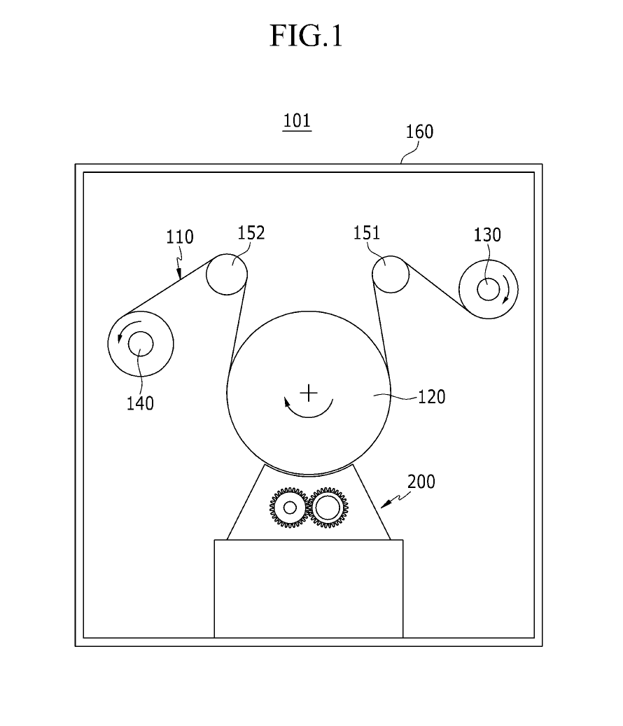

FIG. 1 is a schematic diagram of an electrode fabricating apparatus according to the first exemplary embodiment of the present invention.

Referring to FIG. 1, an electrode fabricating apparatus 101, according to the first exemplary embodiment, includes a vacuum chamber 160, a winding roller 130 and a spiral-wound roller 140 installed inside the vacuum chamber 160 and moving an electrode plate 110, a deposition drum 120 disposed between the winding roller 130 and the spiral-wound roller 140, and a lithium depositor 200 disposed under the deposition drum 120.

The electrode plate 110 may be made of a structure in which an active material layer is coated on a copper thin film formed of a belt shape. Here, the electrode plate 110 is made of a negative electrode plate. The vacuum chamber 160 is formed of a box of a hexahedron shape, and the vacuum chamber 160 is installed with a vacuum pump to maintain an inner portion of the vacuum chamber 160 with a negative pressure.

The electrode plate 110 is wound to the winding roller 130, and the electrode plate 110 moved from the winding roller 130 is wound to the spiral-wound roller 140 through the deposition drum 120.

Also, the electrode fabricating apparatus 101, according to the present exemplary embodiment, further includes a plurality of guide rollers 151 and 152 disposed between the winding roller 130 and the spiral-wound roller 140, and the guide rollers 151 and 152 guide the progression of the electrode plate 110 to convert a progressing direction of the electrode plate 110.

The deposition drum 120 is formed of a cylinder shape and contacts the electrode plate 110 to move the electrode plate 110. A servo motor to rotate the deposition drum 120 is connected and installed to the deposition drum 120, and a moving speed of the electrode plate 110 is determined according to the rotation of the deposition drum 120. The deposition drum 120 is positioned on the lithium depositor 200 such that lithium is coated on the electrode plate 110 supported by the deposition drum 120.

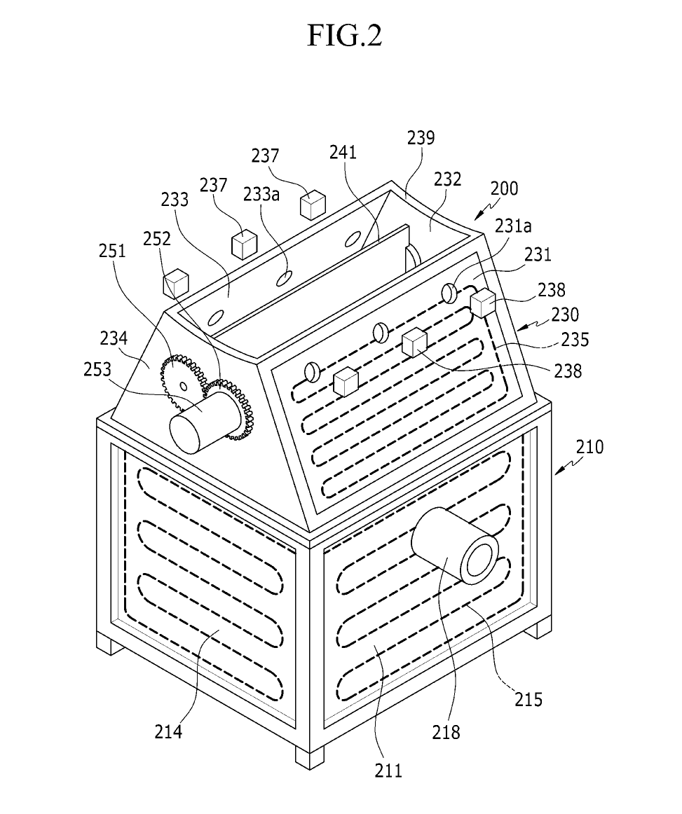

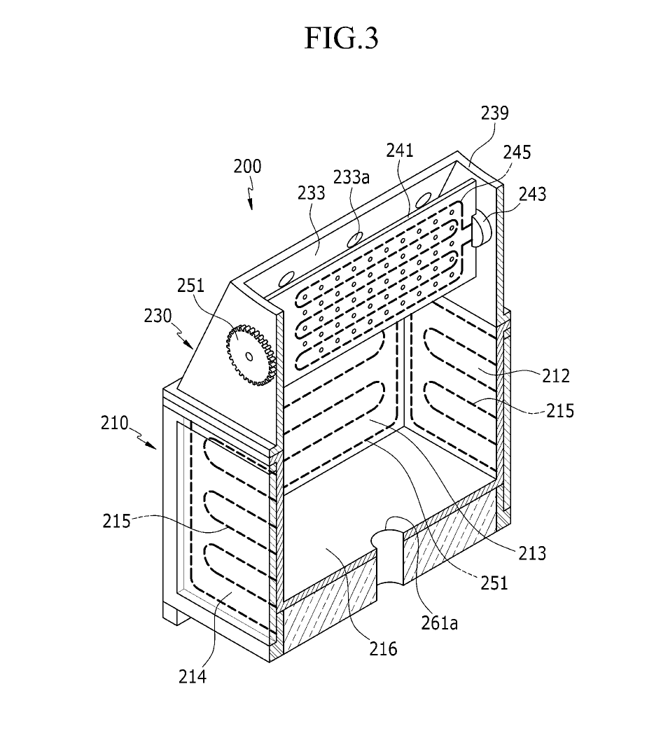

FIG. 2 is a perspective view of a lithium depositor according to the first exemplary embodiment of the present invention, and FIG. 3 is a cut perspective view of a lithium depositor according to the first exemplary embodiment of the present invention.

Referring to FIG. 2 and FIG. 3, the lithium depositor 200 includes an evaporation unit 210 receiving the lithium source and heat-evaporating the lithium source, and a nozzle unit 230 positioned on the evaporation unit 210 and controlling a deposition amount of lithium. The evaporation unit 210 is formed of a box shape in which an upper portion is opened and has four side walls 211, 212, 213, and 214. Heating lines 215 are inserted at the side walls of the evaporation unit 210, and the heating lines 215 heat the evaporation unit 210 to evaporate lithium in a solid state positioned inside the evaporation unit 210. If the solid lithium is heated, it is changed into a liquid state, and if the liquid lithium is further heated, the lithium is evaporated into a gas at between 600° C. and 800° C.

Meanwhile, a lithium supply pipe 218 to supply the lithium is installed at one side wall of the evaporation unit 210 and the lithium is inserted inside the evaporation unit through the lithium supply pipe 218. A drain hole 261a is formed at a bottom 216 of the evaporation unit 210, and when impurities are included in the evaporation unit 210 and foreign particles are mixed, the contaminated lithium is changed into a liquid and may be exhausted outside through the drain hole 261a.

The nozzle unit 230 includes four side walls 231, 232, 233, 234, and a first open/close plate 241 and a second open/close plate 242 are installed inside the nozzle unit 230 to be rotated. The first side wall 232 and the second side wall 234 are disposed to face each other, and the third side wall 231 and the fourth side wall 233 connecting the first side wall 232 and the second side wall 234 are installed between the first side wall 232 and the second side wall 234. The third side wall 231 and the fourth side wall 233 are disposed to be inclined toward the inside. Accordingly, the upper portion of the nozzle unit 230 is narrower than the lower portion thereof, and an opening 239 having a cross-section of an arc shape is formed at the upper end of the nozzle unit.

The cross-section of the first side wall 232 and the second side wall 234 is formed as a trapezoid. Also, heating lines 235 are inserted and installed at the side walls 231, 232, 233, and 234 of the nozzle unit 230 thereby heating the side walls 231, 232, 233, and 234.

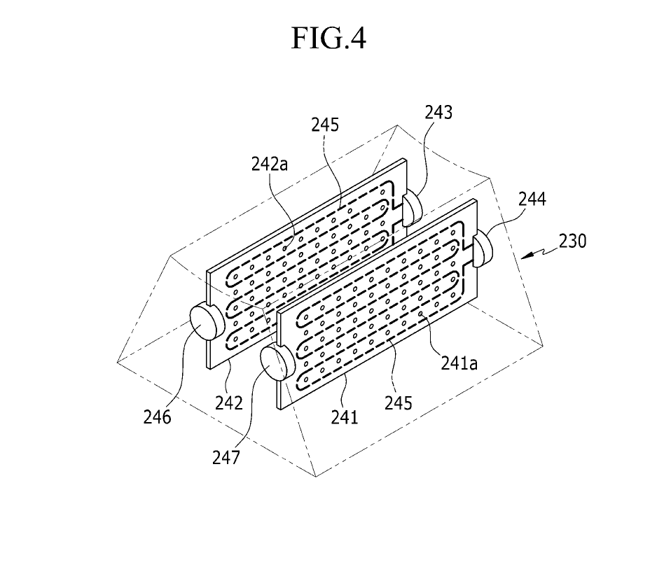

FIG. 4 is a perspective view of an open/close plate according to the first exemplary embodiment of the present invention.

Referring to FIG. 2 to FIG. 4, the first open/close plate 241 and the second open/close plate 242 are installed at the first side wall 232 and the second side wall 234 to be rotated, and the first open/close plate 241 and the second open/close plate 242 are separated in parallel in the width direction of the first side wall 232 and disposed to face each other.

The first open/close plate 241 and the second open/close plate 242 are formed of a long plate shape having an approximate rectangular shape, and the axes are combined at both ends in the length direction to be rotated. Also, heating lines 245 for heating are installed inside the first open/close plate 241 and the second open/close plate 242. The lithium that is evaporated in the evaporation unit 210 and is moved to the nozzle unit 230 is adhered to the surface of the side walls 231, 232, 233, and 234 and the open/close plates 241 and 242 such that the opening area of the nozzle unit 230 may be reduced. However, like the present exemplary embodiment, if the heating lines are installed and inserted to the open/close plate 241 and 242 and the side walls 231, 232, 233, and 234 of the nozzle unit 230, the lithium adhered to the open/close plate 241 and 242 and the side walls 231, 232, 233, and 234 is melted such that the lithium may be recovered to the evaporation unit 210.

A plurality of holes 241a and 242a are formed at the first open/close plate 241 and the second open/close plate 242. In the state that the nozzle unit 230 is closed by the first open/close plate 241 and the second open/close plate 242, if the lithium is continuously evaporated, internal pressure of the lithium depositor 200 is excessively increased such that an explosion warning may be generated. However, if the holes 241a and 242a are formed, the excessive increase of the pressure may be prevented.

A first gear 251 is installed to a rotation axis of the first open/close plate 241, a second gear 252 is installed to the second open/close plate 242, and the first gear 251 and the second gear 252 are coupled to be in cooperation with each other. A control motor 253 controlling the rotation of the first open/close plate 241 is installed to the first open/close plate 241.

Driving axis points 244 and 247 are respectively formed at both side ends of the first open/close plate 241, the first gear 251 and the control motor 253 are connected and installed to one driving axis point 247, and a bearing is provided to the other driving axis point 244. Driving axis points 243 and 246 are respectively formed at both side ends of the second open/close plate 242, the second gear 252 is connected and installed to one driving axis point 246, and a bearing is installed to the other driving axis point 243.

Accordingly, according to the rotation of the control motor 253, the rotation of the first open/close plate 241 and the second open/close plate 242 are controlled, and the deposition amount of the lithium may be controlled according to the rotation of the first open/close plate 241 and the second open/close plate 242.

Further, sensing holes 231a and 233a are respectively installed on the third side wall 231 and the fourth side wall 233. A first sensor 238 is installed at the sensing hole 231a formed at the third side wall 231 to be close thereto, and a second sensor 237 is installed at the sensing hole 233a formed at the fourth side wall 233 to be close thereto. The first sensor 238 and the second sensor 237 are disposed outside the lithium depositor 200 through a supporting member (not shown). The first sensor 238 and the second sensor 237 are formed as laser sensors to measure the deposition amount of the lithium. The first sensor 238 is formed as a light-emitting sensor and the second sensor 237 is formed as a light-receiving sensor such that intensity of a laser that is generated from the first sensor 238 and is transmitted to the second sensor 237 is measured, thereby measuring the amount of lithium supplied from the nozzle unit 230 to the electrode plate 110.

If the amount of lithium is large, the first open/close plate 241 and the second open/close plate 242 are rotated by using the control motor 253 thereby reducing the aperture ratio; if the amount of the lithium is small, the aperture ratio is increased by rotating the first open/close plate 241 and the second open/close plate 242.

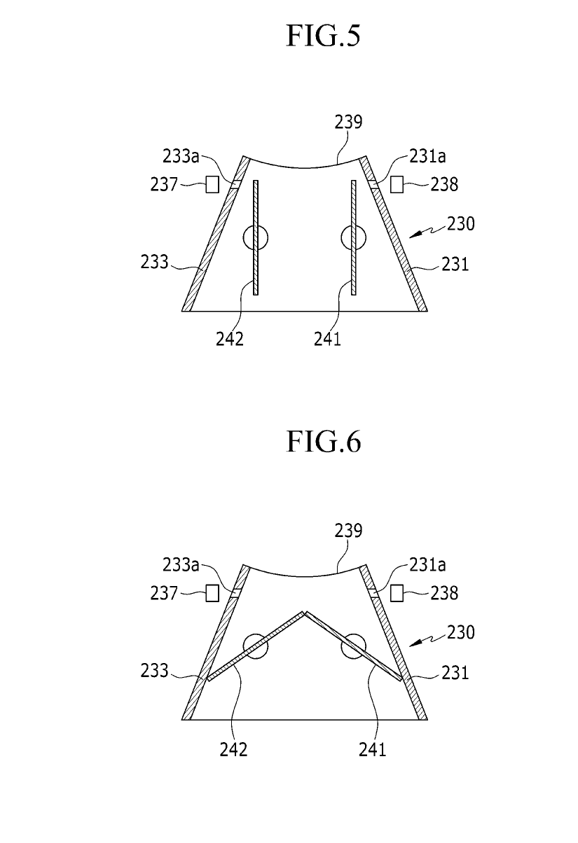

As shown in FIG. 5, by the rotation of the first open/close plate 241 and the second open/close plate 242, according to the present exemplary embodiment, the aperture ratio of the nozzle unit 230 and the deposition amount may be monitored by particularly using the sensors 237 and 238 such that lithium of a uniform amount may be deposited on the electrode plate 110.

Also, as shown in FIG. 6, before the lithium is heated and then reaches the evaporation state, lithium waste may be prevented by closing the nozzle unit 230. Also, since the aperture ratio of the nozzle unit 230 is controlled by the rotation of the first open/close plate 241 and the second open/close plate 242, the aperture ratio may be quickly controlled compared with a blocking structure using one plate such that a more uniform amount of lithium may be deposited on the electrode plate 110.

Lithium ions that remain on the positive electrode before charging are moved to the negative electrode if the charge is progressed, and if the discharge is again performed, the lithium ions that were moved to the negative electrode are moved to the positive electrode, but if the lithium ions of the negative electrode are not all moved to the positive electrode and some lithium ions remain on the negative electrode, the electrons that are moved from the positive electrode to the negative electrode are lacking when performing the recharge, and, as a result, the capacity of the battery is decreased.

However, like the present exemplary embodiment, if the lithium layer is formed by additionally depositing the lithium on the surface of the negative active material, the lithium ions that originally remain on the negative electrode are moved to the positive electrode along with the lithium transmitted from the positive electrode such that the capacity lack may be prevented.

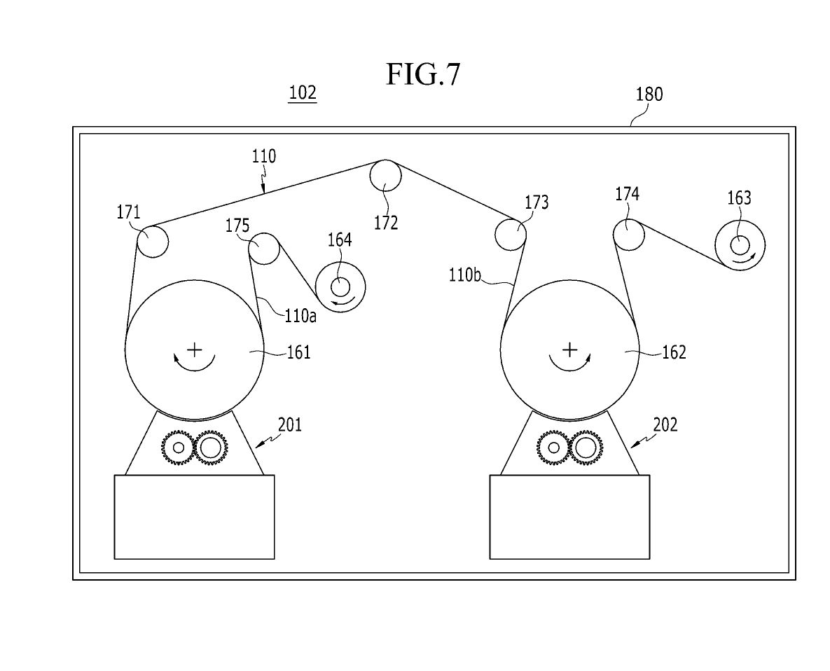

FIG. 7 is a schematic diagram of an electrode fabricating apparatus according to the second exemplary embodiment of the present invention.

Referring to FIG. 7, an electrode fabricating apparatus 102, according to the first exemplary embodiment, includes a vacuum chamber 180, a winding roller 164 and a spiral-wound roller 163 installed inside the vacuum chamber 180 and moving the electrode plate 110, a first deposition drum 161 and a second deposition drum 162 disposed between the winding roller 164 and the spiral-wound roller 163, and a first lithium depositor 201 and a second lithium depositor 202 disposed under the first deposition drum 161.

The electrode plate 110 may have a structure in which an active material layer is coated on a copper thin film formed with a belt shape. Here, the electrode plate 110 has a first surface 110a and a second surface 110b opposite thereto, and the active material layer is coated on both surfaces of the electrode plate 110. The electrode plate 110 is made of the negative electrode plate.

The vacuum chamber 180 is formed as a box of a hexahedron shape, and the vacuum chamber 180 is installed with a vacuum pump to maintain an inner portion of the vacuum chamber 180 with a negative pressure.

The electrode plate 110 is wound to the winding roller 164, and the electrode plate 110 moved from the winding roller 164 is wound to the spiral-wound roller 140 through the first deposition drum 161.

Also, the electrode fabricating apparatus 102, according to the present exemplary embodiment, further includes a plurality of guide rollers 171, 172, 173, 174, and 175 disposed between the winding roller 130 and the spiral-wound roller 140, and the guide rollers 171, 172, 173, 174, and 175 guide the progression of the electrode plate 110 and convert the progressing direction of the electrode plate 110.

The first lithium depositor 201 and the second lithium depositor 202 have the same structure as the lithium depositor according to the first exemplary embodiment such that the overlapping description thereof is omitted.

The first deposition drum 161 is positioned on the first lithium depositor 201, and the first lithium depositor 201 and the first deposition drum 161 deposit the lithium on the first surface 110a of the electrode plate 110. Also, the second deposition drum 162 is positioned on the second lithium depositor 202, and the second lithium depositor 202 and the second deposition drum 162 deposit the lithium on the second surface 110b of the electrode plate 110.

As described above, according to the present exemplary embodiment, the lithium may be deposited on both surfaces of the electrode plate in one vacuum chamber such that efficiency is improved.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. An electrode fabricating apparatus of a rechargeable battery, comprising:
a vacuum chamber having an inner space; and
a lithium depositor receiving a lithium source and having an evaporation unit heating and evaporating the lithium source, and a nozzle unit having an aperture positioned on the evaporation unit wherein the aperture is controlled by controlling an aperture ratio to control a deposition amount of lithium.

2. The electrode fabricating apparatus of claim 1, wherein the nozzle unit includes a first open/close plate installed to be rotated.

3. The electrode fabricating apparatus of claim 2, wherein the nozzle unit includes a second open/close plate disposed to face the first open/close plate and installed to be rotated.

4. The electrode fabricating apparatus of claim 3, wherein the first open/close plate includes a motor rotating the first open/close plate.

5. The electrode fabricating apparatus of claim 4, wherein a rotation axis point of the first open/close plate is connected to and installed with a first gear, and a rotation axis point of the second open/close plate is connected to and installed with a second gear coupled to the first gear.

6. The electrode fabricating apparatus of claim 3, wherein the first open/close plate and the second open/close plate include a heating line.

7. The electrode fabricating apparatus of claim 2, wherein the nozzle unit has a side wall, and a heating line is installed at the side wall.

8. The electrode fabricating apparatus of claim 2, wherein the nozzle unit includes side walls, the side walls facing each other include a sensing hole, and the electrode fabricating apparatus further includes a sensor detecting a deposition amount of the lithium through the sensing hole.

9. The electrode fabricating apparatus of claim 3, wherein a plurality of holes are formed at the first open/close plate and the second open/close plate.

10. The electrode fabricating apparatus of claim 2, wherein the evaporation unit has a side wall, and the side wall is installed with a heating line for heating.

11. The electrode fabricating apparatus of claim 10, wherein a lithium supply pipe to supply the lithium in the evaporation unit is connected and installed at one side wall of the evaporation unit.

12. The electrode fabricating apparatus of claim 10, wherein a bottom of the evaporation unit includes a drain hole to exhaust an impurity.

13. The electrode fabricating apparatus of claim 2, further comprising a winding roller wounded with an electrode, a spiral-wound roller wound with the electrode on which the lithium is deposited, and a moving drum positioned on the lithium depositor and supporting the electrode are installed in the vacuum chamber.

14. The electrode fabricating apparatus of claim 2, further comprising the electrode fabricating apparatus includes two lithium depositors, and one lithium depositor of the lithium depositors deposits the lithium on a first surface of an electrode and the other lithium depositor deposits the lithium on a second surface of the electrode.

15. A lithium deposition device for an electrode fabrication apparatus of a rechargeable battery that deposits lithium on a substrate of the rechargeable battery, the device comprising:
an evaporation unit that defines an interior chamber that receives lithium, wherein the evaporation unit includes a heat source that heats the lithium;
a nozzle positioned on the evaporation unit that has an aperture that is adapted to be positioned proximate to a substrate of the rechargeable battery, wherein the nozzle has a variable opening that is controllable so that the amount of lithium that is provided to the substrate is controlled by the size of the aperture defined by the variable opening.

16. The device of claim 15, wherein the nozzle includes a nozzle housing that defines a first aperture and two movable plates that in combination define a second aperture positioned within the first aperture, wherein the second aperture defines the size of the variable opening.

17. The device of claim 16, wherein the nozzle has a trapezoidal cross section and extends between two side walls and wherein the two movable plates are mounted on parallel axis extending between the first and second plates and rotate between a fully closed position wherein the variable opening is closed and a fully open position wherein the variable opening has a width that is approximately equal to the distance between the parallel axes of the two movable plates.

18. The device of claim 17, further comprising a motor that engages with one of the two movable plates so as to rotate the at least one movable plate.

19. The device of claim 18, further comprising a gear assembly that engages with the motor so that operation of the motor rotates both of the two movable plates.

20. The device of claim 15, wherein the evaporation unit and the nozzle define walls and wherein heating lines are formed within the walls.
